(19) United States
(12) Patent Application Publication
(10) Pub. No.: US 2014/0180749 A1
(43) Pub. Date: Jun. 26, 2014

(54) SCHEDULING MANAGEMENT ENVIRONMENT FOR CORDINATING ALLOCATION OF EXTERNAL RESOURCES TO A PLURALITY OF COMPETING COMPANY ACTIVITIES

(71) Applicant: Paul Woodward, Timmins (CA)

(72) Inventor: Paul Woodward, Timmins (CA)

(21) Appl. No.: 13/724,626

(22) Filed: Dec. 21, 2012

(51) Int. Cl. G06Q 10/06

(52) U.S. Cl. CPC G06Q 10/06314
USPC 705/7.24

(57) ABSTRACT

A method for coordinating limited resources selected from a plurality of limited resources and distributed within a pair of scheduled time periods, the method for execution on a computer processor using stored instructions. The method includes receiving a request for calendar access by a first company; displaying a first time period of the pair of scheduled time periods for a first activity of the first company in a calendar, the display of the first time period including a first set of limited resources with identifying resource information. Also, the method displays a second time period for a second activity of a second company in the calendar, the display of the second time period including a second set of limited resources with identifying resource information. As well as accesses a storage containing the plurality of limited resources associated with one or more category limitations to determine the booking information of a selected limited resource, the booking information pertaining to the selected limited resource contained within the second set of limited resources.

### FIELD

The present invention relates to scheduling.

### BACKGROUND

The ability for a company to schedule and complete a complex company activity is dependent on the local availability of equipment and labour resources. Companies normally need to bolster their internal resources with temporary resources, such as specialized equipment or skill sets, in order to undertake the company activity efficiently. One current disadvantage in industry is the limited availability of the needed temporary resources, especially where the company activity is conducted in a remote location. Therefore, a bottleneck for the planning or scheduling process of the company activity is trying to coordinate and assign available resources to the company activity performed in a selected calendar period, in combination with trying to identify what resources are available in view of geographical and other limitations. It is recognized that the process of scheduling can become very difficult when there is a number of other company activities being planned in and about the same competing selected calendar period, especially where the numerous company activities are being planned by different companies.

### SUMMARY

It is an object of the present invention to provide a scheduling system to obviate or mitigate at least one of the above presented disadvantages.

One current disadvantage in industry is the limited availability of the needed temporary resources, especially where the company activity is conducted in a remote location. Contrary to current systems there is provided a method for coordinating limited resources selected from a plurality of limited resources and distributed within a pair of scheduled time periods, the method for execution on a computer processor using stored instructions. The method includes receiving a request for calendar access by a first company; displaying a first time period of the pair of scheduled time periods for a first activity of the first company in a calendar, the display of the first time period including a first set of limited resources with identifying resource information. Also, the method displays a second time period for a second activity of a second company in the calendar, the display of the second time period including a second set of limited resources with identifying resource information. As well as accesses a storage containing the plurality of limited resources associated with one or more category limitations to determine the booking information of a selected limited resource, the booking information pertaining to the selected limited resource contained within the second set of limited resources. Finally, the method sends the booking information to the first company indicating whether the selected limited resource is available for booking or is booked for the second activity.

A first aspect provided is a method for coordinating limited resources selected from a plurality of limited resources and distributed within a pair of scheduled time periods, the method for execution on a computer processor using stored instructions, the method comprising the steps of: receiving a request for calendar access by a first company; displaying a first time period of the pair of scheduled time periods for a first activity of the first company in a calendar, the display of the first time period including a first set of limited resources with identifying resource information; displaying a second time period for a second activity of a second company in the calendar, the display of the second time period including a second set of limited resources with identifying resource information; accessing a storage containing the plurality of limited resources associated with one or more category limitations to determine the booking information of a selected limited resource, the booking information pertaining to the selected limited resource contained within the second set of limited resources; and sending the booking information to the first company indicating whether the selected limited resource is available for booking or is booked for the second activity.

A second aspect provided is a system for coordinating limited resources selected from a plurality of limited resources and distributed within a pair of scheduled time periods, the system including memory having stored instructions for execution on a computer processor to cause the processor to: receive a request for calendar access by a first company; display a first time period of the pair of scheduled time periods for a first activity of the first company in a calendar, the display of the first time period including a first set of limited resources with identifying resource information; display a second time period for a second activity of a second company in the calendar, the display of the second time period including a second set of limited resources with identifying resource information; access a storage containing the plurality of limited resources associated with one or more category limitations to determine the booking information of a selected limited resource, the booking information pertaining to the selected limited resource contained within the second set of limited resources; and send the booking information to the first company indicating whether the selected limited resource is available for booking or is booked for the second activity.

### BRIEF DESCRIPTION OF THE DRAWINGS

Exemplary embodiments of the invention will now be described in conjunction with the following drawings, by way of example only, in which:

FIG. 1 is a block diagram of a resource management environment;

FIG. 2 is a block diagram of a scheduling coordination service of the environment of FIG. 1;

FIG. 3 is an example interface of the scheduling coordination service of FIG. 2;

FIG. 4 is an example interface of the scheduling coordination service of FIG. 2;

FIG. 5 is an example interface of the scheduling coordination service of FIG. 2;

FIG. 6 is an example interface of the scheduling coordination service of FIG. 2;

FIG. 7 is an example common schedule of the scheduling coordination service of FIG. 2;

FIG. 8 is a further example common schedule of the scheduling coordination service of FIG. 2;

FIG. 9 is an example interface of the scheduling coordination service of FIG. 2;

FIG. 10 is an example interface of the scheduling coordination service of FIG. 2;

FIG. 11 is an example interface of the scheduling coordination service of FIG. 2; and

FIG. 12 is block diagram of a computer device of the resource management environment of FIG. 1.

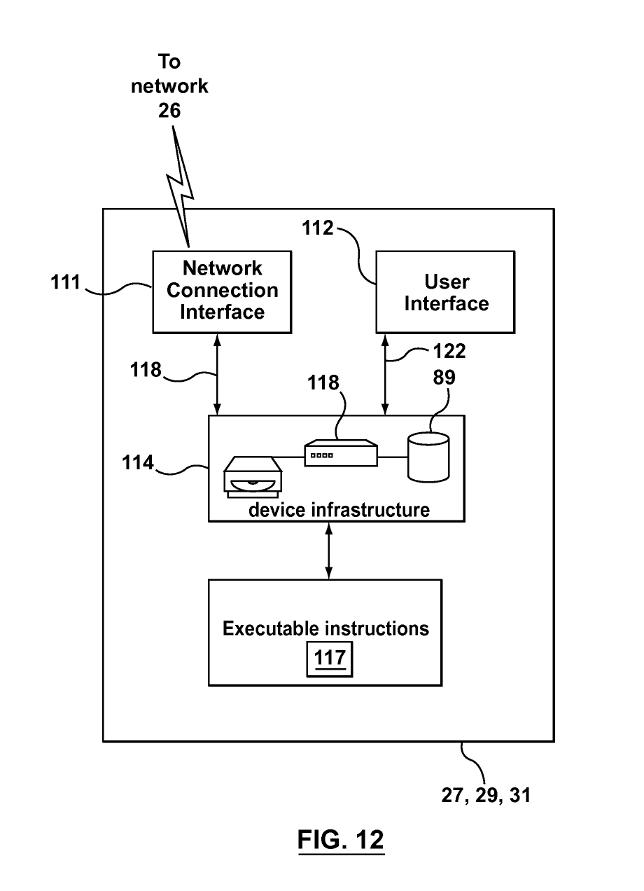

### DESCRIPTION

### Resource Management Environment 10

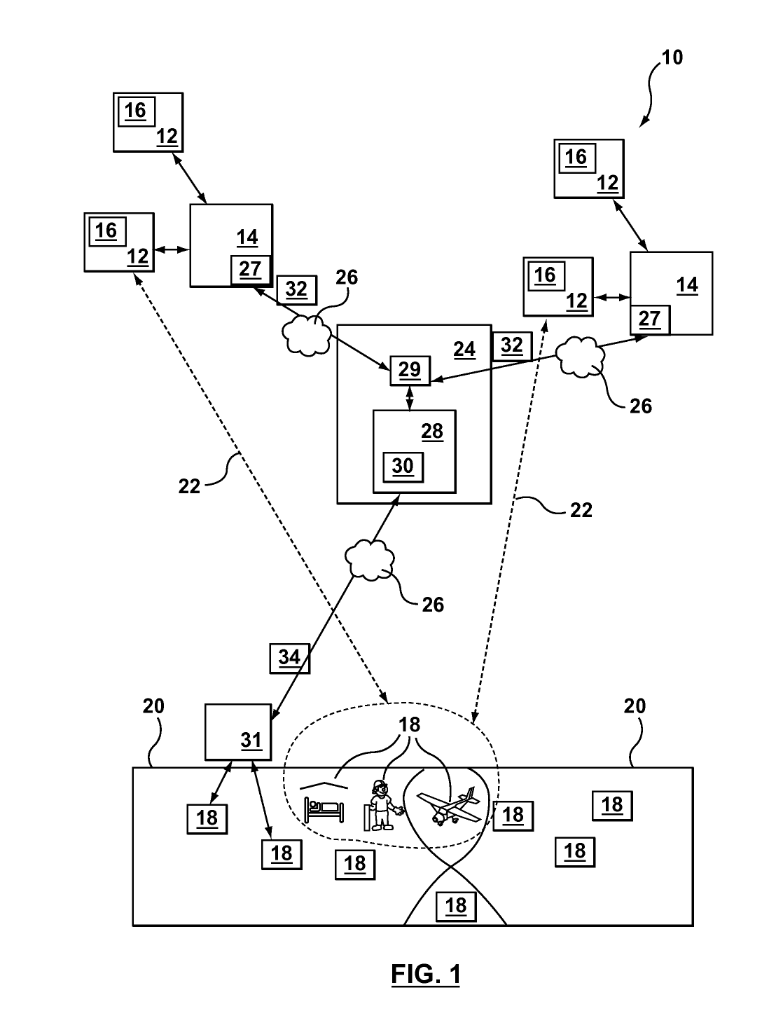

Referring to FIG. 1, shown is a resource management environment 10 for a plurality of company activities 12 coordinated by respective companies 14 in charge of the company activities 12. Company 14 types can include, by example: natural resource companies such as mining, oil and gas, forestry; manufacturing companies such as automotive, steel companies, and other plants; and distribution companies such as product shipping (e.g. boat, rail, truck), courier fleet, and other logistics. The company activities 12 can be, by example, specifically related to the company type such as in mining as either mine construction, mine shutdown (e.g. scheduled maintenance) and/or mine operation. Generically, these company type related activities 12 can be referred to as company construction, company shutdown, and/or company operation. The company activities 12 can also include, by example, non related to the company 14 type and instead are generic for the different company 14 types, such as health and safety training. It is recognized that each of the company activities 12 has internal company resources 16 (e.g. equipment and/or labour) that can be assigned to any of the company activities 12. For example, in terms of mine operation 12 for a mining company 14, example internal company resources 16 would be drilling equipment and equipment operators, which would be used for day to day extraction of the desired natural extracted from the earth via the mine operation. As discussed below, it is recognised that the scheduling management environment 10 facilitates coordination between a plurality of company activities 12 within a specified time period (e.g. a calendar month, a year quarter, a season, etc.) for allocation of external resources 18 with respect to a plurality of competing company activities 12 within the specified time period.

It is also recognized that each of the companies 14 may have periodic needs for external resources 18 (e.g. equipment and/or labour) that can be contracted out for a specified period of time to supplement (or replace) some or all of the internal company resources 16 for a specified company activity 12 (e.g. seasonal increase in company activity 12 resource requirements). The companies 14 may also have periodic needs for external resources 18 (e.g. equipment and/or labour) that can be contracted out by the company 14 for a specified period of time to initiate a periodic company activity 12 (e.g. a scheduled company shutdown for scheduled equipment maintenance). It is recognized that the need for external resources 18 can be impacted by the availability of the external resources 18 for the specified period of time, including competition between the company activities for those external resources 18. For example, in the case where extra workers for a remotely located mine operation 12 are required to start on a specific start day and then end on a specific end day, transportation (e.g. airplane) would be required to fly the extra workers in for the start day and to fly them out again after the end day. If there are a limited number of airplanes servicing the remote area in which the mine is located, then availability of the airplanes and also the extra workers may be problematic, especially if there are other remote mine operations in the same remote area. Accordingly, appropriate scheduling of the external resources 18 (of the extra workers and the airplane(s)) for the specified start and end days could become problematic in situations of limited external resources 18.

### External Resources 18

As shown in FIG. 1, the external resources 18 can be specified as belonging to a specified category limitation 20, for those external resources 18 that match the specified category limitation 20. In this manner, a plurality of the external resources 18 can be grouped into one or more category limitations. A specified category limitation 20 can be a limitation such as but not limited to: specific geographical region(s); specific company 14 type(s) (e.g. mining); specific company activity type(s) (e.g. shutdown, health an safety training, etc.); specific geographical region(s) for specific company 14 type(s); specific geographical region for specific company activity type(s); specific geographical region(s) for specific company 14 type(s) for specific company activity type(s); etc. It is recognized that different external resources 18 can be associated with more than one specified category limitation 20, for example as shown by the plane 18 belonging to both of the specified category limitations 20.

One example of specified category limitation 20 would be all external resources 18 that are available for health and safety training for mining in northern Alberta. Following this example, as shown in FIG. 1, the external resources 18 for workers, hotel rooms and planes would be available from a specified category limitation 20 of health and safety workers for mining, airplanes and local hotel rooms for northern Alberta. As can be appreciated, in the event that these example external resources 18 are desired (shown by ghosted lines 22) for a pair of different company activities 12 in the same or overlapping time periods (either by the same or different companies 14), then availability of these external resources 18 may be problematic and thereby affect the appropriate timing of the company activities 12. Scheduling can be particularly problematic when the pair of company activities 12 are administered/coordinated by different companies 14.

The internal company resources 16 and the external resources 18 can be defined as resources that are a source or supply from which benefit is produced. Typically resources can be materials, equipment, personnel/labour (e.g. skilled workers) or other assets that are transformed or otherwise used in the company activity 12 to produce benefit for the company 14 and in the process can be consumed or made unavailable. A resource can also be defined as a commodity, service, or other asset used to produce goods and/or services by the company activity 12 that meet human needs and wants. Alternatively, a resource can be a commodity, service, or other asset used to configure assets of the company 14 or company activity 12 (e.g. train personnel, maintain equipment, etc.) to further the production of the goods and/or services by the company activity 12 (or other company activity 12 of the company 14). Resource supply and demand, as identified as available from the specified category limitation 20, can influence the production of goods and services by the company activity 12 to meet human needs and wants. Resources can be broadly defined to include one or more of land, labor, and capital. Land can include natural resources (e.g. consumables) and can be viewed as both the site of production and the source of raw materials. Labor or human resources can consist of human effort provided in the creation of products, for example paid in wage or in kind. Labour or human resources can also be defined as the skills, energies, talents, abilities and/or knowledge that is/are used in for the production of goods or the rendering of services to facilitate the production of goods. Capital (or infrastructure) can consist of human-made goods or means of production (machinery, buildings, and other infrastructure) used in the production of other goods and services. As resources, capital goods may or may not be significantly consumed, though they may depreciate when used in the company activity 12 and they can be typically of limited capacity or unavailable for use by others.

### Schedule Coordination Service 24

As can be appreciated by the above, securing the appropriate external resources 18 for a specific company activity 12 can be problematic in view of competing interests by company activities 12 of the same or different company(ies) 14. This can be compounded by limited time periods when certain company activities 12 can take place (e.g. only during the summer months). Therefore, the resource management environment 10 also includes a schedule coordination service 24 that communicates with the external resources 18 over a network 26, on behalf of the companies 14 for example, in order to help coordinate a common schedule 28 (e.g. calendar) that includes scheduling information 30 of the external resources 18 that is accessible to two or more companies 14 and/or two or more company activities 12 within the same company 14. One example of two or more companies 14 is where each company 14 is scheduling a plant shutdown that would be independent of each other if the external resources 18 were unlimited. One example of two or more company activities 12 within the same company 14 is where each company activity 12 is scheduled by a different company department (e.g. a shutdown for one plant process and a health and safety program for another plant process), such that each company activity 12 would be independent of each other if the external resources 18 were unlimited. In the case of unlimited external resources 18, there would be no activity concerns by either company activity 12 as they would each have sufficient resources to undertake and complete their respective company activity 12.

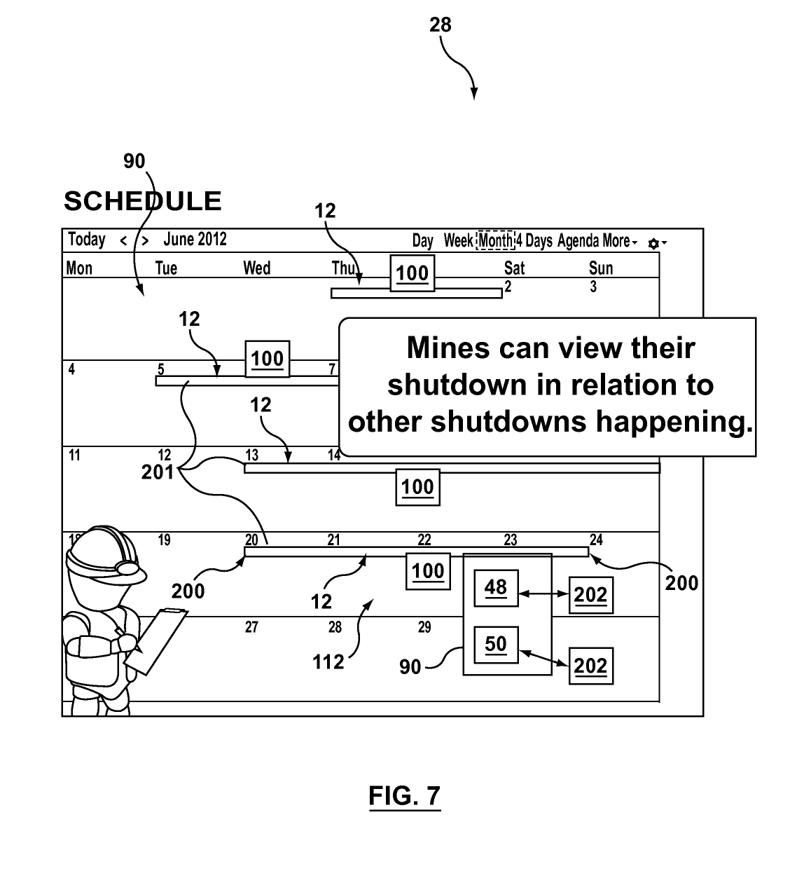

It is recognised that the display of company activities 12 within the common schedule 28 for the specified time period can be dependent upon the category limitation 20. For example, only those company activities 12 having one or more activity parameters 90 (see FIG. 7) matching the category limitation 20 would be displayed in the common schedule 28, based on an access request by the company for the common schedule 28 containing multiple different time periods representing respective company activities 12. For example, the category limitation 20 could be mines in northern Alberta, and therefore an access request for only company activities 12 related (i.e. having activity parameters 90 associated with mining in northern Alberta) to mines in northern Alberta would be displayed in the common schedule 28. For example, company activities 12 for forestry in northern Alberta may not be displayed in the common schedule 28 as they would not have any activity parameters 90 associated with the category limitation 20 (e.g. personnel 50, equipment 48 and specific location impacting hotel and travel accommodation specific to mining in northern Alberta). Another example is where company activities 12 for mining in Ontario may not be displayed in the common schedule 28 as they would not have and activity parameters 90 associated with the category limitation 20 (e.g. personnel 50, equipment 48 and specific location impacting hotel and travel accommodation specific to mining in northern Alberta).

Preferably, the communications network 26 comprises a wide area network such as the Internet, however the network 26 may also comprise one or more local area networks 26, one or more wide area networks, or a combination thereof. Further, the network 26 need not be a land-based network, but instead may comprise a wireless network and/or a hybrid of a land-based network and a wireless network for enhanced communications flexibility. In terms of communications on the network 26, these communications 32 can be between computer devices 27, 29 consisting of addressable network packages following a network communication protocol (e.g. TCPIP), such that the communications 32 can include at least a portion of the scheduling information 30. As well, these communications 34 can also be the addressable network packages (e.g. email) and/or telephone communication between resource providers 31 and the schedule coordination service 24. For example, the resource providers 31 could be one or more contacting companies providing the rental of equipment 18 and/or subcontracting of personnel 18 to the company activities 12 via the schedule coordination service 24. It is also recognized that the resource providers 31 could represent the external resource 18 itself, such as in independent contractor that is a labourer (e.g. welder). Further, it is also recognised that the schedule coordination service 24 can receive employment applications in the communications 32 from providers 31 seeking employment. As such, these employment applications (e.g. employment wanted) can be posted in a job bank section of the network service (e.g. Web service) provided by the schedule coordination service 24. Further, it is also recognised that the schedule coordination service 24 can receive resource (e.g. employment) postings in the communications 32 from companies 14 seeking employees, equipment, and/or contractors. As such, these resource postings (e.g. employment offered) can be posted in the job bank section of the network service (e.g. Web service) provided by the schedule coordination service 24. Also contemplated is a “for sale” (or trade in kind) section of the schedule coordination service 24. For example, the providers 31 (or any other third parry equipment owner) could send equipment offer messages 32 to the schedule coordination service 24 containing description and “cost” as an offer for sale/trade of the described equipment 18. The schedule coordination service 24 would post the equipment offer messages 32 in the “for sale” section of the network service, made available for access by the companies 14, other providers 31, as well as any other interested third party.

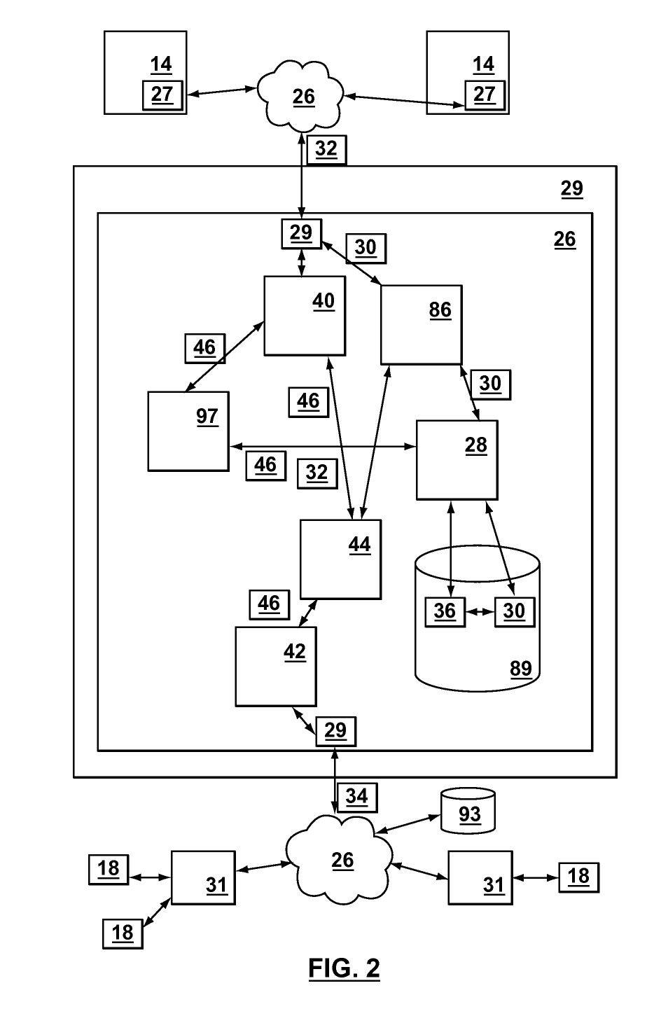

Referring to FIG. 2, shown is the schedule coordination service 24 that is implemented on one or more computer devices 29 that are connected to the companies 14 and the resource providers 31 via the network 26. The coordination service 24 can be provided as a network (e.g. web) service that is accessible over the network 26 by the companies 14 (e.g. via computer devices 27) and by the resource providers computers 3. The schedule coordination service 24 can be configured as a network interface which provides for a method of communication between two of more computer devices 27,29,31 over the network 26, in order to access the scheduling information 30 containing availability information 36 about individual external resources 18 (and optionally groups of external resources 18). For example, the scheduling information 30 and associated availability information 36 can be stored in a storage 40 for use in presentation of the common schedule 28, as further described below.

In terms of the network service provided by the schedule coordination service 24, the network service can be defined as a software system designed to support interoperable machine-to-machine interaction over the network 26. The network service can have an interface described in a machine-processable format (e.g. Web Services Description Language, known by the acronym WSDL) or others as desired. The other networked devices 27,31 interact with the network service in a manner prescribed by its description using network messages 32,34 (e.g. SOAP), typically conveyed using a defined network communications protocol (e.g. HTTP with an XML serialization in conjunction with other network-related standards). In terms of the network service as a Web service, the Web service can be provided as a REST-compliant Web services in which the primary purpose of the service is to manipulate XML representations of Web resources using a uniform set of “stateless” operations; and/or an arbitrary Web service in which the service may expose an arbitrary set of operations. A further example of the schedule coordination service 24 is configured as a downloadable application (e.g. calendar application) that can be used by the companies 14 via their computer resources (e.g. in off-line situations with respect to the network 26). In this manner, the companies 14 can use the downloadable version to define activity information of their specific company activity time periods 112 with associated resource requests information 48,50 (see FIG. 7) and then subsequently upload the defined activity information to the schedule coordination service 24 via the network 26. Once uploaded, the schedule coordination service 24 can incorporate the defined activity information in the common schedule 28 for access and display by the companies 14 via access requests.

Referring again to FIG. 2, the schedule coordination service 24 has a company communication interface module 40 for communicating with the companies 14 over the network 26. The communication interface module 40 is responsible for receiving information requests from the companies 14 and for sending information responses in response as well as for sending notification messages, all generically referred to as communication messages 32. It is recognised that the communication messages 32 can be implemented in synchronous or asynchronous messaging, as appropriate. The schedule coordination service 24 also has a provider communication interface module 42 for communicating with the providers 31 over the network 26. The communication interface module 42 is responsible for receiving information requests from the providers 31 and for sending information responses in response as well as for sending notification messages, all generically referred to as communication messages 34. It is recognised that the communication messages 34 can be implemented in synchronous or asynchronous messaging, as appropriate. For example, the communication interface module 40 and the communication interface module 42 can be provided as separate or common modules, as desired.

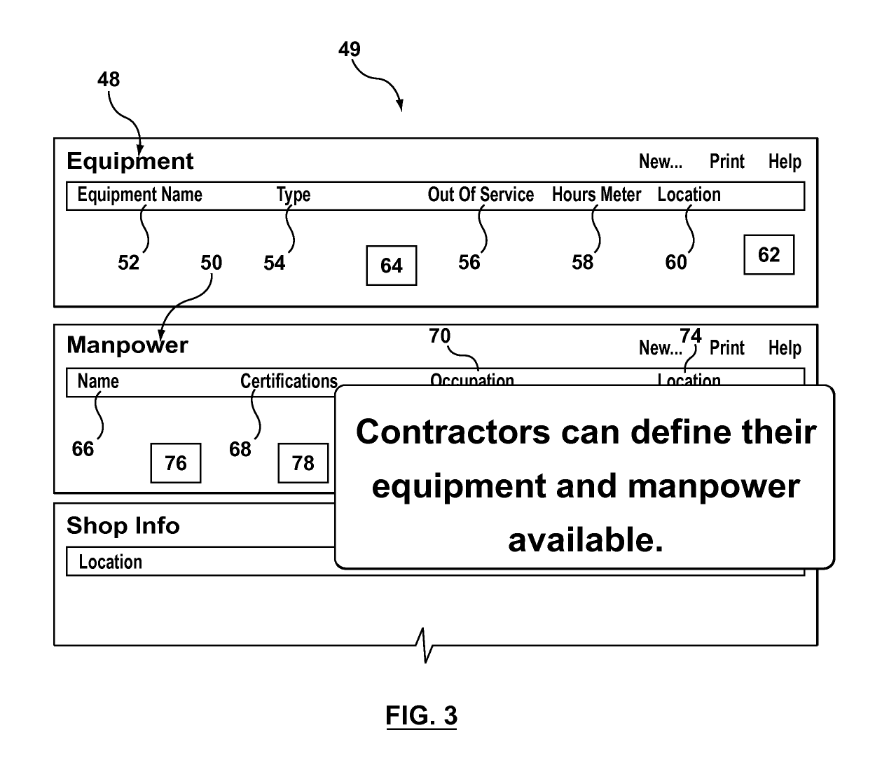

Referring again to FIG. 2, the schedule coordination service 24 also has a registration module 44 for receiving and processing registration information 46 of the companies 14, the company activities 12, the resource providers 31, as well as the external resources 18 (e.g. resource information 49) themselves. For example, referring to FIG. 3, the resource providers 31 can provide resource information 49 as part of the registration information 46, specifying whether the external resource 18 is equipment 48 or personnel 50. In terms of each equipment 48, the information 49 can include information parameters such as but not limited to: equipment name 52; equipment type 54; location 56; hours meter 58; whether the equipment is in operation or out of service 60; and related rental/purchase costs 62. For example, each provider 31 can specify the requisite resource information 49 for each equipment 48 made available to the category limitation(s) 20 pertinent to the schedule coordination service 24. In addition to location 56 (and optionally cost 62), the provider 31 can also provide in the resource information 49 other category parameters 64 that can be used to classify the equipment 48 as belonging to the one or more category limitation(s) 20, as optionally defined (and used) by the schedule coordination service 24—further described below. Examples of the other category parameters 64 can be parameters such as but not limited to: equipment maintenance records, equipment safety/operational certifications, restricted time periods, available time periods, mandatory equipment operator qualifications, transportation requirements, etc.

Referring again to FIG. 3, the resource providers 31 can provide resource information 49 specifying for each personnel 50, information parameters such as but not limited to: name 66; certifications 68 (e.g. health and safety training certifications); occupation 70; particular occupation skills 72; location 74; and costing 76. In addition, the provider 31 can also provide in the resource information 49 other category parameters 78 that can be used to classify the personnel 50 as belonging to the one or more category limitation(s) 20, as optionally defined (and used) by the schedule coordination service 24—further described below. Examples of the other category parameters 78 can be parameters such as but not limited to: contact information; address; years of experience or experience level; list of other skills; resume of previous projects and/or company work history; etc.

The schedule coordination service 24 can also provide a browsing module 86, which can be used to access scheduling information 30 available via the common schedule 28 (see FIG. 7). Also, the browsing module 86 could be used to access equipment safety/operational certifications and/or the certifications 68 (e.g. health and safety training certifications) via one or more storages, which can be the same as storage 89 of the schedule coordination service 24 and/or can be a remote storage 93 hosted external to the schedule coordination service 24. One example of the remote storage 93 is a database of employee health and safety records that contain health and safety training data that indicates whether specific personnel 50 meet property specific training requirements for the jobs/tasks required of them by the company activity 12.

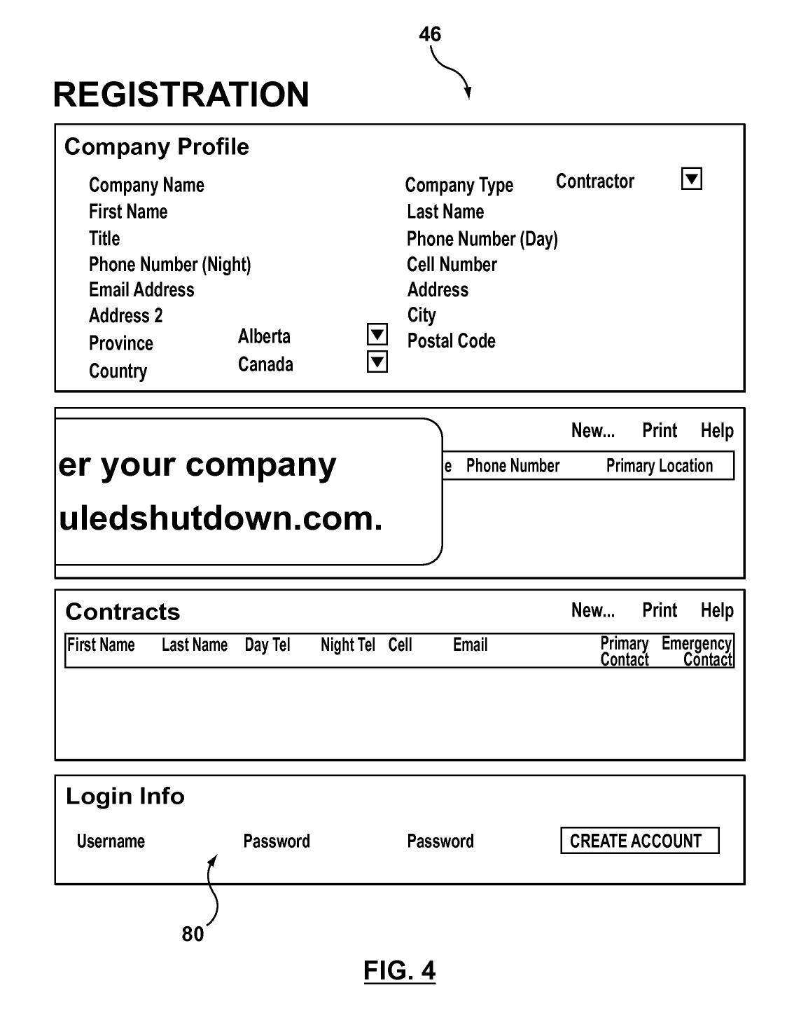

Referring to FIG. 4, shown is an example of registration information 46 (e.g. submission screen of the network interface of the schedule coordination service 24) of the companies 14 that can be used to provide information to the registration module 44. Based on the registration information 46 of the company 14, the registration module 44 can generate a user account 80 for the company 14 with the schedule coordination service 24, which can be subsequently used by the company 14 to gain access to the common schedule 28 as well as to submit external resource 18 requests (associated with one or more company activities 12 represented in the common schedule 28) to the schedule coordination service 24 via messages 32.

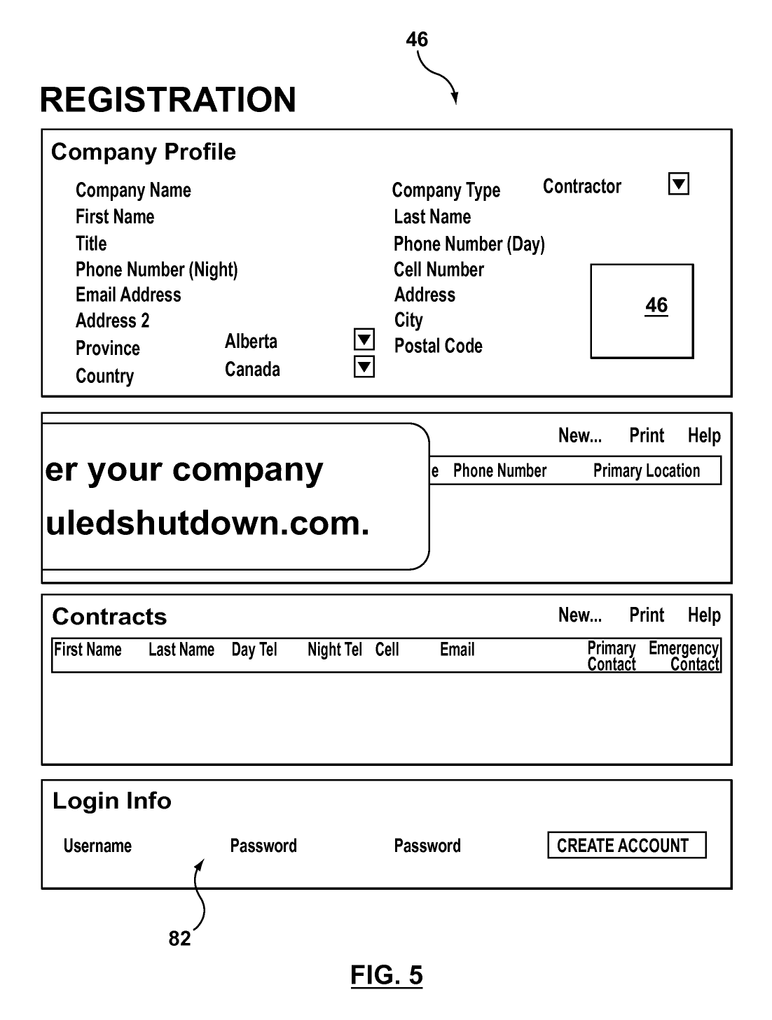

Referring to FIG. 5, shown is an example of registration information 46 (e.g. submission screen of the network interface of the schedule coordination service 24) for the providers 31 that can be used to provide information to the registration module 44. Based on the registration information 46 of the provider 31, the registration module 44 can generate a user account 82 for the provider 31 with the schedule coordination service 24, which can be subsequently used by the provider 31 to gain access to the common schedule 28 as well as to submit individual external resource 18 availability information 84 (for subsequent use in request and association with one or more company activates 12 represented in the common schedule 28) to the schedule coordination service 24 via messages 34. The resource information 49 (see FIG. 3) can also be associated with the registration information 46 of the provider 31.

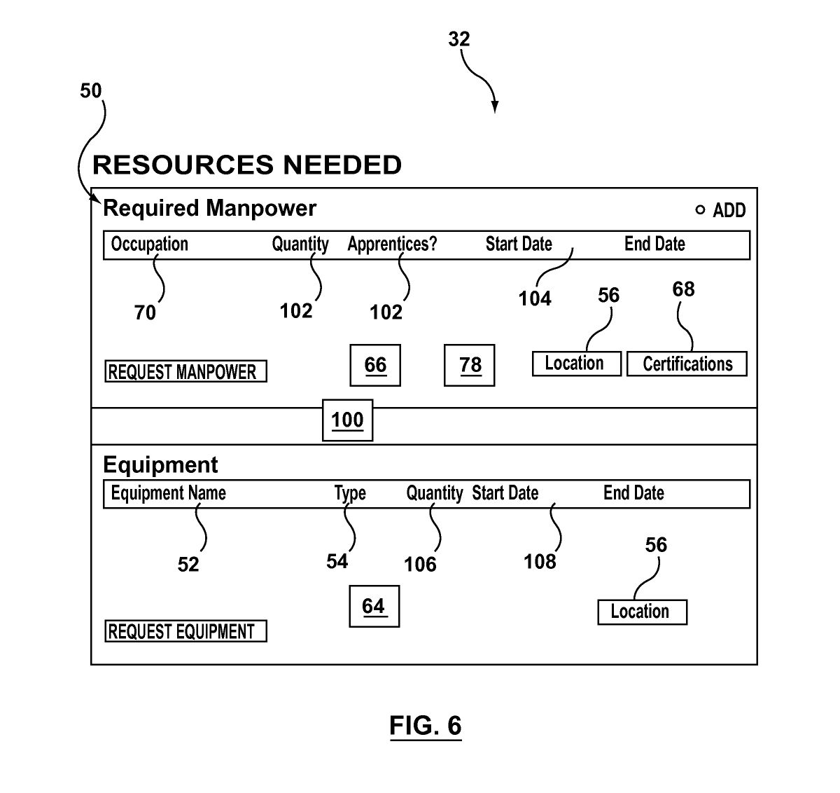

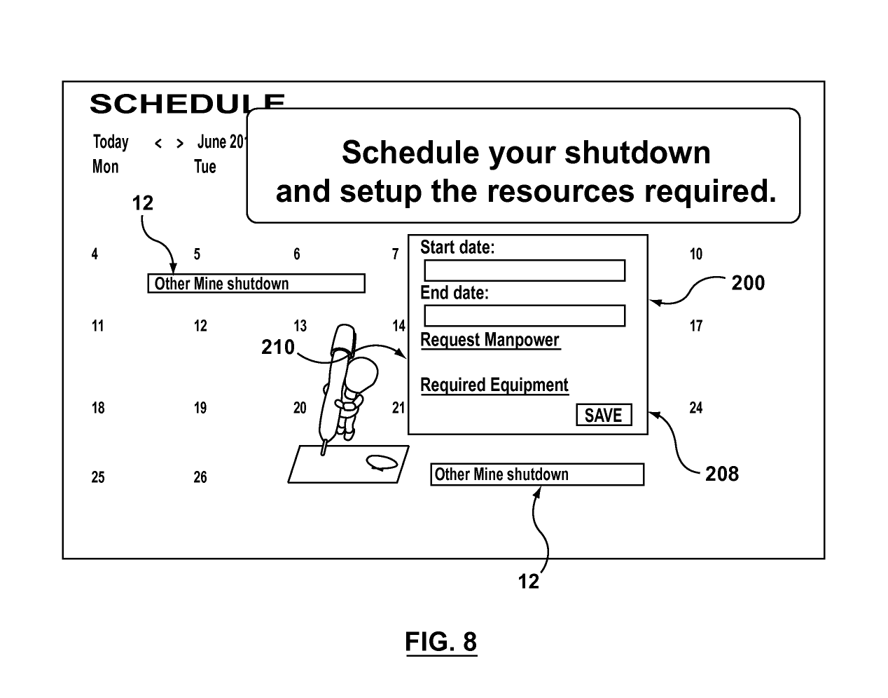

As discussed above, for the external resource 18 requirements of the specific company activity 12, the company 14 can communicate (via the computer device 27) specifics of the company activity 12 to the schedule coordination service 24 via the registration module 44, as external resource request messages 32. Information associated with these external resource request messages 32 can be linked to the company activity time period 112 defined by the company 14 for access and display via the common schedule 28 (see FIG. 7). For example, referring to FIG. 6, shown is an example submission screen of the network interface of the schedule coordination service 24 that can be used to submit the external resource request messages 32 for a specified company activity 12. For example, the message 32 contents can include information such as but not limited to: company activity 12 identification 100 (or activity ID) that can be used by the schedule coordination service 24, the providers 31 and the companies 14 to uniquely associate and identify the respective company activity 12 in the common schedule 28. The external resource 18 request for each personnel 50 can include, such as but not limited to: certifications 68 (e.g. health and safety training certifications); occupation 70; number of 102; particular occupation skills 72; location 74; and start and end date 104 which would correspond with the start and end date 200 in the common schedule 28 (see FIG. 8) of the company activity 12 identified by the respective activity ID 100. For example, the start and end date 104 can be the same as the start and end date 200. Alternatively, the start and end date 104 can be within the chronological bounds of the start and end date 200. Further, it is recognised that the resource request can specify the name 66 and/or any of the other category parameters 78.

The external resource 18 request for each equipment 48 can include, such as but not limited: equipment name 52; equipment type 54; location 56; quantity 106; and start and end date 108 which would correspond with the start and end date 200 in the common schedule 28 (see FIG. 8) of the company activity 12 identified by the respective activity ID 100. For example, the start and end date 108 can be the same as the start and end date 200. Alternatively, the start and end date 108 can be within the chronological bounds of the start and end date 200. Further, the start and end date 108 can be the same or different than the start and end date 104. Additionally, it is recognised that the resource request can specify any other category parameters 64 that can be used to classify the equipment 48 as belonging to the one or more category limitation(s) 20, as optionally defined (and used) by the schedule coordination service 24—further described below. It is also recognised that the start and end dates 104,108 can be the same or different for each external resource 18 instance in the external resource 18 request of message 32. For example, each personnel 50 can have similar or different start dates to others in the group of external resources 18 requested by the company 14.

Referring again to FIG. 2, shown is the browsing module 86 that is used by the companies 14 to access the common schedule 28 (see FIG. 7), which lists all of the relevant company activities 12 adjacent (or overlapping—where the end date of a first time period is after the start date of a second time period in the common schedule 28) in time (e.g. within the same calendar month). For example, the companies 14 can first browse the existing company activities 12 in the common schedule 28, including specific scheduling information 30 of each of the existing company activities 12, so as to help them make an informed choice in terms of scheduling their own company activity 12 and associated external resource 18 needs.

Each of the company activities 12 in the common schedule 28 has a number of associated parameters 90 that are accessible to each of the companies 14 via the common schedule 28. The associated parameters 90 can be visible as text labels associated with a schedule bar 201 of each activity time period 112. Alternative formats of the parameters 90 can be mouse overs, drop down boxes, or any other user interface mechanism to facilitate data clutter management. These parameters 90 for each of the activities 12 in the common schedule 28 can include scheduling information 30 (see FIG. 1) such as but not limited to: activity ID 100 that could list a name of the project, a project type (e.g. shutdown, health and safety training, etc.), project start and end date 200; specific equipment 48 associated with the project, including any of the resource details discussed with respect to FIG. 3 or FIG. 6; specific personnel 50 associated with the project, including any of the resource details discussed with respect to FIG. 3 or FIG. 6; an indication 202 as to whether the respective personnel 50 associated with the project or equipment 48 associated with the project has been confirmed as available (e.g. confirmation of booking between the provider 31 and the company 14); and/or company 14 contact information (e.g. pop-up box to send direct email by browsing module 86 on behalf of the sender) for the specified activity 12 to facilitate communication between company coordinators/managers for different projects/activities 12 (e.g. for example in the event of emergency equipment replacement in the event of failure).

As discussed above, the provision and access by providers 31 and companies 14 to the common schedule 28 (and scheduling information 30 contained therein) facilitates the company activity 12 planners to inhibit external resource 18 scheduling overlap in view of today's ever shrinking external resource 18 pool. The common schedule 28 can be embodied as an integrated calendar that can be a stand alone calendar as hosted on the schedule coordination service 24 and accessed via the browsing module 86. The common schedule 28 can be embodied as a source of calendar information that can be exported (e.g. as an application of the schedule coordination service 24) to Outlook or other calendar software resident on the computer devices 27 of the companies 14 or that of the providers 31. As such, it is recognised that the common schedule 28 can represent a calendar with real time scheduling information 30 distributed in a number of different activity time periods 112, which are updated as received communications 32 from the companies 14 via the communication interface module 40 or by the providers 31 via the communication interface module 42. For example, one of the updates could be a confirmation of availability by a provider 31 for a resource posting of a specific activity time period 112, which then could be included by the schedule coordination service 24 in the information 30 associated with the activity 112 in the common schedule 28. Alternatively, one of the updates could used to change the resource information 30 and/or period scheduling information 30 (e.g. start/stop dates) of the activity 12 by the schedule coordination service 24. The real time scheduling information 30 can be used to represent information about company activities 12 such as shutdown projects, health and safety training projects; and any other external resource 18 usage projects.

It is recognised that some of the associated parameters 90 can be available to the company 14 that registered the specified company activity 12 in the common schedule 28, however access to these same associated parameters 90 would restricted by a company 14 that did not registered the specified company activity 12. In this manner, classified portions of the schedule information 30 of the company 14 (e.g. specific project costing) can be withheld from other companies 14.

Referring again to FIG. 2, the schedule coordination service 24 can also have a scheduler module 97, which can receive the information 46 from the company 14 that is specific to a company activity 12 that is: to be scheduled (e.g. a new company activity 12 to add to the common schedule 28); contains amendments to the parameters 90 of an existing company activity 12 in the common schedule 28; and/or contains deletions to on or more parameters 90 of an existing company activity 12 in the common schedule 28. For example, the contents of the information 46 can be similar to that described in conjunction with FIG. 6. In this manner, the companies 14 can use the scheduler module 97 to coordinate parameters 90 for new company activities 12, amend parameters 90 for current company activities 12, add new parameters 90 for current company activities 12 and/or delete parameters 90 for current company activities 12, including the ability to modify/change start/stop dates 104,108,200, times, personnel 50, duties of personnel 50, equipment 48 (e.g. tooling), and other specific company activity 12 related functions that can be represented in the common schedule 28.

The scheduler module 97 can also tabulate and carry all booked personnel 50 and/or equipment 48 and provide the company planner of the company activity 12 with total hrs actually utilized during any given company activity 12. Various formats can be provided via the communication interface modules 40,42 to provide the user to input average cost per hour, thusly facilitating the determination of a total cost on the company activity 12 (e.g. shutdown).

Other advantages provided by the schedule coordination service 24 via the common schedule 28 can include booking or reserving of manpower (e.g. personnel 50) with multiple companies or contractors (e.g. provides 31) for specific customer requirements. Multiple fields of input can be provided for submission of the registration information 46 (see FIGS. 3 and 6) such as specialty tooling, specific health and safety requirements and training. Also considered is that all users (e.g. companies 14 and providers 31) can be put in touch with one another via the network communications 32,34 (e.g. via the schedule coordination service 24) for facilitating streamlined and seamless communications there between for scheduling purposes of the company activities 12.

### Example Operation of the Schedule Coordination Service 24

Referring to FIGS. 7 and 8, the company 14 checks the common schedule 28 via the browsing module 86 to determine start and stop dates 200 for existing company activities 12 for a selected time period (e.g. a calendar month). The company 14 can also browse the specific parameters 90 that have public access within the common schedule 28 that are associated with the company activities 12, for example for those company activities 12 that match matching a category limitation 20 as specified/selected by the company 14 (e.g. safety training for mining near Edmonton). Next the company 14 can submit a company activity registration request 32 (see FIG. 2), including registration information 46 (for example see FIG. 6), via request interface 208. Request interface 208 includes specification of the start and stop dates 200 of the company activity 12, as well as selection options 210 for each of the equipment 48 and personnel 50 order options. For example, selection of option 210 could provide the user with an order interface as shown in FIG. 6.

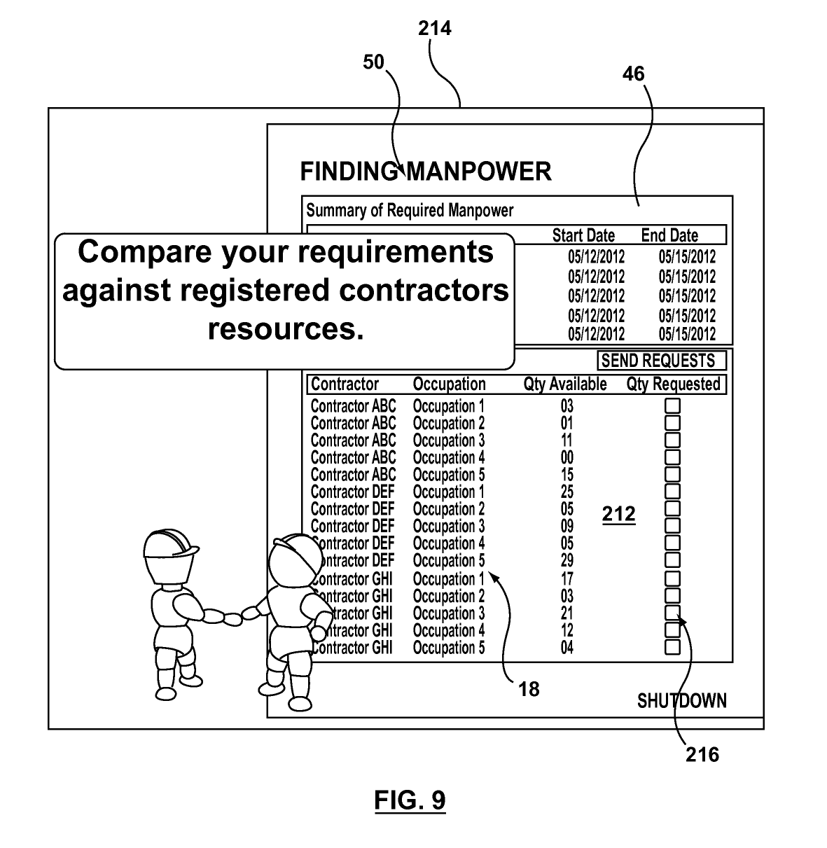

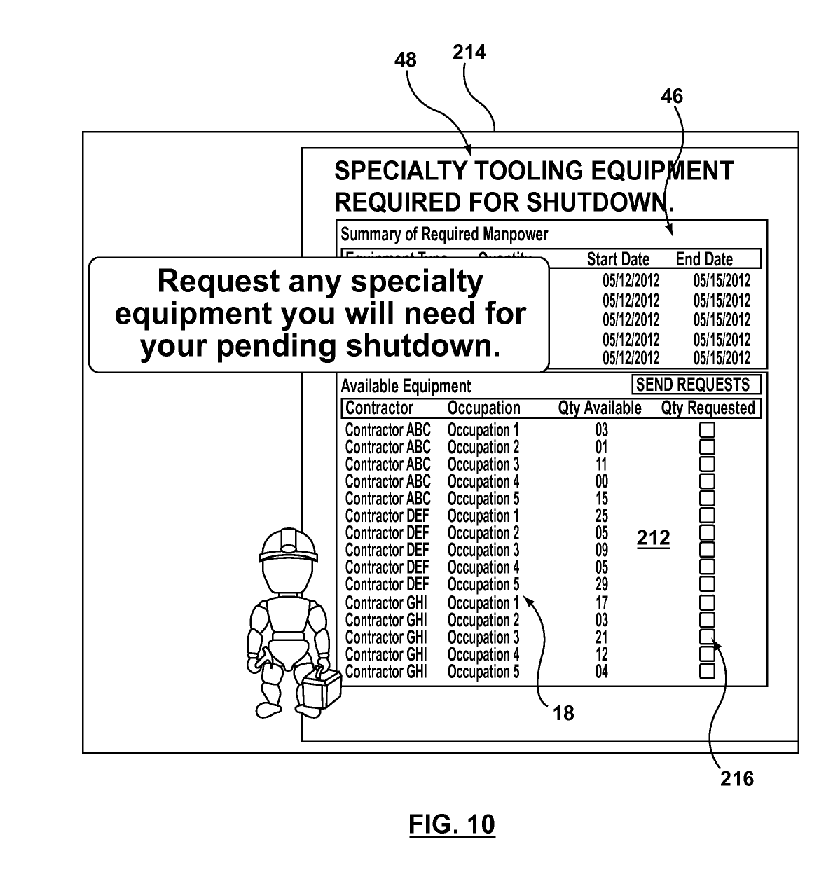

As part of, or before entering specific registration information 46 for the desired external resources 18, as shown in FIG. 9 the browser module 86 could be used to browse and compare available external resources 18 already submitted by the providers 31, for example for those company activities 12 that match matching a category limitation 20 as specified/selected by the company 14 (e.g. safety training for mining near Edmonton). For example, the browser module 86 could receive the submitted registration information 46 via request interface 208, match the listed external resource 18 requested in the registration information 46 (for example for those external resources 18 that match matching a category limitation 20 as specified/selected by the company 14—safety training for mining near Edmonton) and then display the matched 212 external resources 18 in a match interface 214. A similar match interface 214 is shown in FIG. 10 for equipment 48. Accordingly, if any of the suggested matches are suitable, the user can select the specific external resource(s) 18 via selection boxes 216, which would then be added to the company activity 12 and assorted parameters 90 accessible via the common schedule 28, as added/amended by the scheduler module 97. For example, prior to adding the selected matches, the browser module 86 would cooperate with the communication interface module 42 to send a booking request message 34 to the provider(s) 31 of the selected external resources(s) 18, and upon confirmation of booking would then instruct or otherwise inform the scheduler module 97 that the confirmed external resources(s) 18 can be added to the respective company activity 12 in the common schedule 28.

Referring to FIG. 10, shown is a pending request interface 218 that can be assessed via the browser module 86 by the company 14, in order to see which of their requests for external resources 18 have yet to be selected/confirmed by one or more of the providers 31. It is also recognized that an interface similar to that of pending request interface 218 can be accessed by any of the providers 31, such that they can select via selection boxes 216 of any external resource(s) 18 they wish to provide to the company activity 12. Accordingly, the browser module 86 would cooperate with the communication interface module 42 to send/receive a booking confirmation request message 34 from the provider(s) 31 of the selected external resources(s) 18, and upon confirmation of booking would then instruct or otherwise inform the scheduler module 97 that the confirmed external resources(s) 18 can be added to the respective company activity 12 in the common schedule 28.

As discussed, shown in the Figures is a system 10 for coordinating limited resources selected from a plurality of limited resources and distributed within a pair of scheduled time periods. The method includes: receiving a request for calendar access by a first company via the service 24; displaying via the service 24 a first time period of the pair of scheduled time periods for a first activity of the first company in a calendar, the display of the first time period including a first set of limited resources with identifying resource information; displaying via the service 24 a second time period for a second activity of a second company in the calendar, the display of the second time period including a second set of limited resources with identifying resource information; accessing via the service 24 a storage containing the plurality of limited resources associated with one or more category limitations to determine the booking information of a selected limited resource, the booking information pertaining to the selected limited resource contained within the second set of limited resources; and sending via the service 24 the booking information to the first company indicating whether the selected limited resource is available for booking or is booked for the second activity.

### Example Storage 18,23

In view of the above descriptions of storage 89,93 for the computer devices 27,29,31 (see FIG. 2) can be configured as keeping the stored data (scheduling information 30) in order and the principal (or only) operations on the stored data are the addition/amendment of or removal of the stored data from storage 89,93 (e.g. FIFO, FIAO, etc.). For example, storage 89,93 can be a linear data structure for containing and subsequent accessing of the stored data and/or can be a non-linear data structure for containing and subsequent accessing of the stored data.

Further, storage 89,93 receives various entities such as data that are stored and held to be processed later. In these contexts, storage 89,93 can perform the function of a buffer, which is a region of memory used to temporarily hold data while it is being moved from one place to another (i.e. between the between computer devices 27,29,31). Typically, the data is stored in the memory when moving the data between processes within/between one or more computers. It is recognised that storage 89,93 can be implemented in hardware, software, or a combination thereof. The storage 89,93 is used in the network system 10 when there is a difference between the rate/time at which data is received and the rate/time at which the data can be processed (e.g. ultimately by the devices 27,29,31).

Further, it will be understood by a person skilled in the art that memory/storage 89,93 described herein is the physical place where data can be held in an electromagnetic or optical form for access by the computer processors/modules. There can be two general usages: first, memory is frequently used to mean the devices and data connected to the computer through input/output operations such as hard disk and tape systems and other forms of storage not including computer memory and other in-computer storage. Second, in a more formal usage, memory/storage 89,93 has been divided into: (1) primary storage, which holds data in memory (sometimes called random access memory or RAM) and other “built-in” devices such as the processor's L1 cache, and (2) secondary storage, which holds data on hard disks, tapes, and other devices requiring input/output operations. Primary storage can be faster to access than secondary storage because of the proximity of the storage to the processor or because of the nature of the storage devices. On the other hand, secondary storage can hold much more data than primary storage. In addition to RAM, primary storage includes read-only memory (ROM) and L1 and L2 cache memory. In addition to hard disks, secondary storage includes a range of device types and technologies, including diskettes, Zip drives, redundant array of independent disks (RAID) systems, and holographic storage. Devices that hold storage are collectively known as storage media.

A database is one embodiment of memory 89,93 as a collection of information that is organized so that it can easily be accessed, managed, and updated. In one view, databases can be classified according to types of content: bibliographic, full-text, numeric, and images. In computing, databases are sometimes classified according to their organizational approach. The most prevalent approach is the relational database, a tabular database in which data is defined so that it can be reorganized and accessed in a number of different ways. A distributed database is one that can be dispersed or replicated among different points in a network. An object-oriented programming database is one that is congruent with the data defined in object classes and subclasses. Computer databases typically contain aggregations of data records or files, such as transactions, catalogs and inventories, and profiles. Typically, a database manager provides users the capabilities of controlling read/write access, specifying report generation, and analyzing usage. Databases and database managers are prevalent in large mainframe systems, but are also present in smaller distributed workstation and mid-range systems such as the AS/400 and on personal computers. SQL (Structured Query Language) is a standard language for making interactive queries from and updating a database such as IBM's DB2, Microsoft's Access, and database products from Oracle, Sybase, and Computer Associates.

Memory/storage 89,93 can also be defined as a physical electronic holding place for instructions and data that the computer's microprocessor can reach quickly. When the computer is in normal operation, its memory usually contains the main parts of the operating system and some or all of the application programs and related data that are being used. Memory is often used as a shorter synonym for random access memory (RAM). This kind of memory is located on one or more microchips that are physically close to the microprocessor in the computer.

In terms of a server, it is recognised that the computer devices 27,29,31 can be configured as hardware, software, or typically a combination of both hardware and software to provide a network entity that operates as a socket listener. It is recognised that any computerised process that shares a resource (e.g. data) to one or more client processes can be classified as a server in the system 10. The term server can also be generalized to describe a host that is deployed to execute one or more such programs, such that the host can be one or more configured computers that link other computers or electronic devices together via the network 26. The computer devices 27,29,31 implementing functionality of the service 24 can provide specialized services across the network 26, for example to private users inside a large organization or to public users via the Internet 26. In the system 10, the servers can have dedicated functionality and/or can share functionality as described. Enterprise servers are servers that are used in a business context and can be run on/by any capable computer hardware. In the hardware sense, the word server typically designates computer models intended for running software applications under the heavy demand of a network 26 environment. In this client-server configuration one or more machines, either a computer or a computer appliance, share information with each other with one acting as a host for the other. While nearly any personal computer is capable of acting as a network server, a dedicated server will contain features making it more suitable for production environments. These features may include a faster CPU, increased high-performance RAM, and typically more than one large hard drive. More obvious distinctions include marked redundancy in power supplies, network connections, and even the servers themselves.

### Example of Computer Device 27,29,31

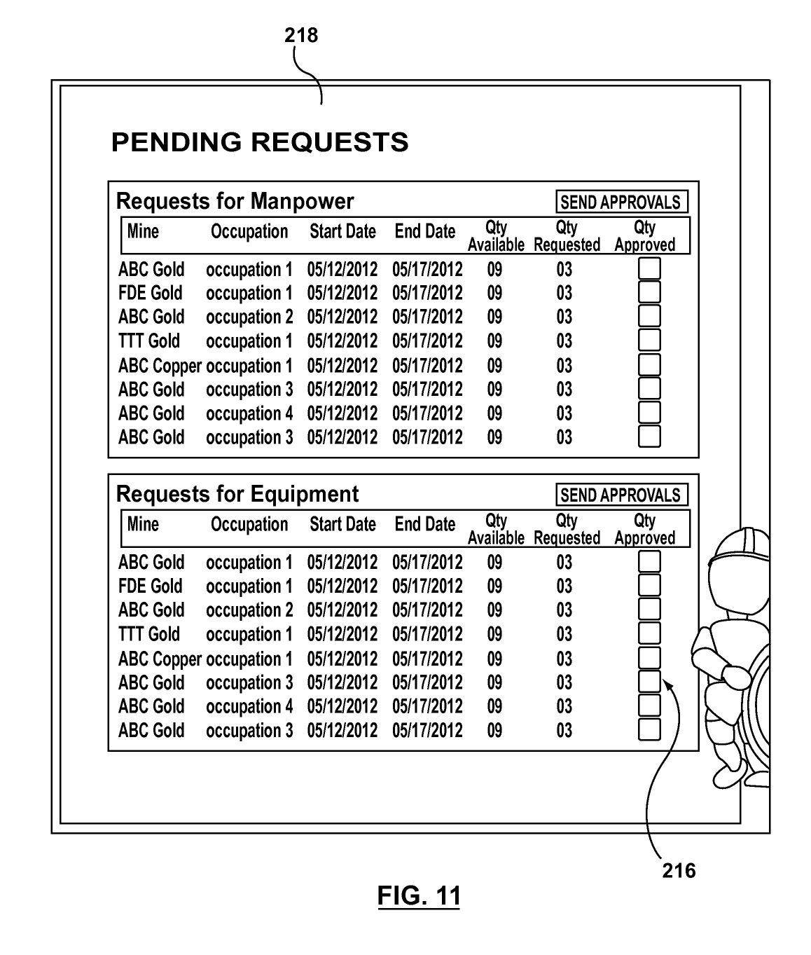

Referring to FIG. 11, a computing device 27,29,31 implementing functionality of service 24, company 14 messaging 32 and provider messaging 34 can include a network connection interface 111, such as a network interface card or a modem, coupled via connection 118 to a device infrastructure 114. The connection interface 111 is connectable during operation of the devices to the network 26 (e.g. an intranet and/or an extranet such as the Internet), which enables the devices to communicate with each other as appropriate. The network 26 can support the communication of the communications 32, 34, and the related content.

Referring again to FIG. 11, the device 27,29,31 can also have a user interface 112, coupled to the device infrastructure 114 by connection 122, to interact with a user (e.g. server administrator—not shown). The user interface 112 can include one or more user input devices such as but not limited to a QWERTY keyboard, a keypad, a stylus, a mouse, a microphone and the user output device such as an LCD screen display and/or a speaker. If the screen is touch sensitive, then the display can also be used as the user input device as controlled by the device infrastructure 114.

Referring again to FIG. 11, operation of the device 27,29,31 is facilitated by the device infrastructure 114. The device infrastructure 114 includes one or more computer processors 118 and can include an associated memory 89. The computer processor 118 facilitates performance of the device 27,29,31 configured for the intended task (e.g. of the respective module(s) of service 24) through operation of the network interface 111, the user interface 112 and other application programs/hardware of the device 27,29,31 by executing task related instructions. These task related instructions can be provided by an operating system, and/or software applications located in the memory 89, and/or by operability that is configured into the electronic/digital circuitry of the processor(s) 118 designed to perform the specific task(s). Further, it is recognized that the device infrastructure 114 can include a computer readable storage medium coupled to the processor 108 for providing instructions to the processor 118 and/or to load/update the instructions 117 (e.g. modules 40,42,44,86,97). The computer readable medium can include hardware and/or software such as, by way of example only, magnetic disks, magnetic tape, optically readable medium such as CD/DVD ROMS, and memory cards. In each case, the computer readable medium may take the form of a small disk, floppy diskette, cassette, hard disk drive, solid-state memory card, or RAM provided in the memory module. It should be noted that the above listed example computer readable mediums can be used either alone or in combination.

Further, it is recognized that the computing device 27,29,31 can include the executable applications comprising code or machine readable instructions for implementing predetermined functions/operations including those of an operating system and the modules, for example. The processor 118 as used herein is a configured device and/or set of machine-readable instructions for performing operations as described by example above, including those operations as performed by any or all of the modules. As used herein, the processor 118 may comprise any one or combination of, hardware, firmware, and/or software. The processor 118 acts upon information by manipulating, analyzing, modifying, converting or transmitting information for use by an executable procedure or an information device, and/or by routing the information with respect to an output device. The processor 118 may use or comprise the capabilities of a controller or microprocessor, for example. Accordingly, any of the functionality of the modules may be implemented in hardware, software or a combination of both. Accordingly, the use of a processor 118 as a device and/or as a set of machine-readable instructions is referred to generically as a processor/module for sake of simplicity. Further, it is recognised that the service 24 can include one or more of the computing devices 29 (comprising hardware and/or software) for implementing the modules, as desired.

It will be understood in view of the above that the computing devices 27,29,31 may be, although depicted as a single computer system, may be implemented as a network of computer processors, as desired.

1. A method for coordinating limited resources selected from a plurality of limited resources and distributed within a pair of scheduled time periods, the method for execution on a computer processor using stored instructions, the method comprising the steps of:
receiving a request for calendar access by a first company;
displaying a first time period of the pair of scheduled time periods for a first activity of the first company in a calendar, the display of the first time period including a first set of limited resources with identifying resource information;
displaying a second time period for a second activity of a second company in the calendar, the display of the second time period including a second set of limited resources with identifying resource information;
accessing a storage containing the plurality of limited resources associated with one or more category limitations to determine the booking information of a selected limited resource, the booking information pertaining to the selected limited resource contained within the second set of limited resources; and
sending the booking information to the first company indicating whether the selected limited resource is available for booking or is booked for the second activity.

2. The method of claim 1, wherein the identifying resource information is selected from the group consisting of: a category limitation of the one or more category limitations; a name of the respective limited resource; contact information of the respective limited resource; certification information of the respective limited resource; health and safety record of the respective limited resource; maintenance record of the respective limited resource; location of the respective resource; cost of the respective limited resource.

3. The method of claim 2, wherein one or more portions of the identifying resource information of the second set of limited resources is classified as restricted access by the first company.

4. The method of claim 1 further comprising the step of assigning a plurality of activity parameters to each of the first activity and the second activity.

5. The method of claim 4, wherein the activity parameters are selected from the group consisting of: activity type; company type; and activity geographical location;

6. The method of claim 5 further comprising the step of receiving an activity parameter from the first company as part of the calendar access request and selecting the display of the first time period and the second time period based on said activity parameter.

7. The method of claim 5 further comprising the step of receiving an activity parameter from the first company as part of the calendar access request and displaying limited resources matching the activity parameter in the first set of limited resources and the second set of limited resources, wherein at least one category limitation of each of the displayed limited resources matches the activity parameter.

8. The method of claim 7, wherein the at least one category limitation is selected from the group consisting of: specific equipment type; specific personnel type; specific geographical region; specific company type; specific company activity type; specific geographical region for specific company type; specific geographical region for specific company activity type; and specific geographical region for specific company type for specific company activity type.

9. The method of claim 1, wherein the first time period and second time period are displayed as overlapping with respect to one another.

10. The method of claim 1, wherein the plurality of limited resources are selected from the group consisting of: labour; equipment; travel arrangements; and accommodation arrangements.

11. The method of claim 1, wherein the first company activity and the second company activity are selected from the group consisting of: company construction; company shutdown; company operation; and health and safety training.

12. The method of claim 1, wherein the first company and the second company are of the same company type.

13. The method of claim 1, wherein the first company and the second company are of different company types.

14. The method of claim 1, wherein the first company and the second company are different company departments for the same company.

15. The method of claim 12, wherein the company type is selected from the group consisting of: mining; forestry; and manufacturing.

16. The method of claim 1 further comprising the steps of: receiving identifying resource information of an available limited resource provided by a provider; and storing the available limited resource in the storage with the plurality of limited resources according to a category limitation included in the identifying resource information.

17. The method of claim 1 further comprising the steps of: receiving a limited resource request from the first company; and associating the limited resource request with the first time period displayed in the calendar.

18. The method of claim 1 further comprising the steps of: receiving a selection of the limited resource request by a provider of a limited resource matching the limited resource request; and sending a notification of the selection to the first company.

19. The method of claim 1 further comprising the step of sending a notification message to the second company indicating an overlapping limited resource in the first set of limited resources with a corresponding limited resource in the second set of limited resources.

20. The method of claim 19, wherein the overlapping limited resource and the corresponding limited resource are in conflict such that they are the same limited resource.

21. A system for coordinating limited resources selected from a plurality of limited resources and distributed within a pair of scheduled time periods, the system including memory having stored instructions for execution on a computer processor to cause the processor to:
receive a request for calendar access by a first company;
display a first time period of the pair of scheduled time periods for a first activity of the first company in a calendar, the display of the first time period including a first set of limited resources with identifying resource information;
display a second time period for a second activity of a second company in the calendar, the display of the second time period including a second set of limited resources with identifying resource information;
access a storage containing the plurality of limited resources associated with one or more category limitations to determine the booking information of a selected limited resource, the booking information pertaining to the selected limited resource contained within the second set of limited resources; and
send the booking information to the first company indicating whether the selected limited resource is available for booking or is booked for the second activity.
